(19) United States
(12) Patent Application Publication
(10) Pub. No.: US 2025/0122907 A1
(43) Pub. Date: Apr. 17, 2025

(54) CAGE FOR BALL BEARING AND BALL BEARING COMPRISING SAME

(71) Applicant: ILJIN GLOBAL Co.,Ltd, Seoul (KR)

(72) Inventors: Chang Ki LEE, Seoul (KR); Ji Wook CHOI, Incheon (KR); Hyeon Soo LIM, Hwaseong-si Gyeonggi-do (KR); Woon Ju LEE, Yongin-si Gyeonggi-do (KR)

(73) Assignee: ILJIN GLOBAL Co.,Ltd, Seoul (KR)

(21) Appl. No.: 18/989,861

(22) Filed: Dec. 20, 2024

Related U.S. Application Data
(63) Continuation of application No. PCT/KR2023/010780, filed on Jul. 25, 2023.

(30) Foreign Application Priority Data
Jul. 25, 2022 (KR) 10-2022-0092079

(51) Int. Cl. F16C 33/38; F16C 33/66

(52) U.S. Cl. CPC F16C 33/3887; F16C 33/6681

(57) ABSTRACT

A cage for a ball bearing is provided. A cage for a ball bearing includes a cage main body having a ring shape; a plurality of partitions which extend in an axial direction of the cage main body and are formed spaced apart in a circumferential direction of the cage main body; and pocket formation parts which are formed around the plurality of partitions. According to an example embodiment of the present disclosure, the pockets may be formed between the plurality of partitions adjacent to each other and the pocket formation parts may be formed to surround the pockets. Also, the oil storage parts may be formed on at least one of an outer surface and an inner surface of the pocket formation parts in a radial direction of the cage main body so that oil stored in the oil storage parts is supplied to the pockets.

### CROSS-REFERENCE TO RELATED APPLICATIONS

This application is a continuation of International Application No. PCT/KR2023/010780 filed on Jul. 25, 2023, which claims priority to Korean Patent Application No. 10-2022-0092079 filed on Jul. 25, 2022, the entire contents of which are herein incorporated by reference.

### TECHNICAL FIELD

The present disclosure relates to a cage for a ball bearing and a ball bearing including the same, and more particularly to a cage for a ball bearing with improved lubrication and a ball bearing including the same.

The present disclosure has been derived from a study conducted as Material Component Technology Development Project of Korea Evaluation Institute of Industrial Technology of Ministry of Trade, Industry and Energy [Project Number: 1415179692, Research Subject Name: 20000RPM P5 class high precision bearing design and manufacturing technology development for electric vehicles].

### BACKGROUND ART

In recent years, a demand for eco-friendly vehicles including electric vehicles has been rapidly increasing due to factors such as strengthening environmental regulations and fuel efficiency regulations and rising oil prices. The drive systems of electric vehicles are configured to include an electric motor and a reducer. In addition, with the increase in demand for electric vehicles, technique development for high-speed and high-output of drive systems of electric vehicles is also actively underway. For example, techniques which increase the rotation speeds of electric motors are being developed to improve efficiency by increasing the specific outputs of the electric motors.

In line with the trend toward higher speeds in the drive systems of such electric vehicles, bearings used in electric motors and reducers also need to be designed to be suitable for high-speed rotation. Moreover, as the needs for low torque, low friction, and low noise increase, bearing design which takes these into account is also necessary.

A ball bearing that is a type of rolling bearing is mainly used as bearings for high-speed rotation. A ball bearing has two raceway rings (inner and outer rings) and a plurality of balls as rolling elements which roll between them. Thus, the contact area between the rolling elements and the raceway rings is relatively small, making it suitable for high-speed rotation.

The ball bearing further includes a cage which maintains a plurality of balls at a predetermined interval along the circumference of the raceway rings. In such ball bearings, lubricating oil typically flows between the two raceway rings and the cage to lubricate the raceway surfaces and rolling elements.

Here, when a ball bearing rotates at high speed, the presence of the cage may prevent smooth lubrication of the raceway surfaces and rolling elements, which may result in increased friction and noise. Particularly, at the time of starting a vehicle without lubricating oil being supplied to the inside of the ball bearing, there is a risk of premature damage to the bearing due to the large frictional heat generated.

Further, when the ball bearing rotates at high speed, the cage may be deformed due to a centrifugal force or the like, and as a result, interference between the cage and the balls increases so that a function of holding the balls may not be performed smoothly and problems such as increased heat due to friction occur.

### SUMMARY

### Technical Problem

The present disclosure is intended to solve the matters in the related art as stated, and the present disclosure is for the purpose of providing a cage for a ball bearing and a ball bearing with improved lubrication.

In addition, the present disclosure is also for the purpose of providing a cage for a ball bearing and a ball bearing which are capable of reducing interference between the cage and balls even at high speed rotation.

### Technical Solution

Representative configurations of the present disclosure to achieve the above-described purposes are as follows.

According to an example embodiment of the present disclosure, a cage for a ball bearing is provided. A cage for a ball bearing according to an example embodiment of the present disclosure may comprise: a cage main body having a ring shape; a plurality of partitions which extend in an axial direction of the cage main body and are formed spaced apart in a circumferential direction of the cage main body; and pocket formation parts which are formed around the plurality of partitions. According to an example embodiment of the present disclosure, pockets may be formed between the plurality of partitions adjacent to each other and the pocket formation parts may be formed to surround the pockets. Also, the oil storage parts may be formed on at least one of an outer surface and an inner surface of the pocket formation parts in a radial direction of the cage main body so that oil stored in the oil storage parts is supplied to the pockets.

According to an example embodiment of the present disclosure, the pocket formation part may have at least one of the protrusion parts formed to protrude and the oil storage parts may partitioned into two or more compartments by the at least one of the protrusion parts. According to an example embodiment of the present disclosure, in the pocket formation part, two of the protrusion parts may be formed to protrude and the oil storage parts may be partitioned into a first storage part adjacent to the cage main body, and a second storage part and a third storage part adjacent to the partition on both sides of the first storage part by the two protrusion parts.

According to an example embodiment of the present disclosure, a thickness of the at least one of the protrusion parts in a radial direction of the cage main body may be formed to be the same as a thickness of the plurality of partitions.

According to an example embodiment of the present disclosure, a thickness of the oil storage parts formed in the pocket formation part in a radial direction of the cage main body may be formed smaller than a thickness of the plurality of partitions.

According to an example embodiment of the present disclosure, the pocket formation part may comprise a ball support part formed to protrude further than the plurality of partitions in a direction in which it is away from the cage main body.

According to an example embodiment of the present disclosure, the first oil storage parts may be formed on an outer surface in a radial direction of the pocket formation part and the second oil storage parts may be formed on an inner surface in the radial direction of the pocket formation part.

According to an example embodiment of the present disclosure, a ball bearing is provided. A ball bearing according to an example embodiment of the present disclosure may comprise: an inner ring; an outer ring which is disposed opposite the inner ring; a plurality of balls which is disposed between the inner ring and the outer ring and spaced apart from each other at a predetermined interval; and a cage which is disposed between the inner ring and the outer ring and configured to maintain the plurality of balls at a predetermined interval.

In addition, a cage for a ball bearing and a ball bearing according to the present disclosure may further comprise other additional configurations without departing from the technical sprit of the present disclosure.

### Advantageous Effects

According to the present disclosure, it is possible to improve lubrication by smoothly supplying lubricating oil even when a ball bearing rotates at high speed. Particularly, according to the present disclosure, it is possible to supply oil stored in oil storage parts to balls even at the initial start-up, thereby reducing friction and suppressing the generation of frictional heat.

Also, according to the present disclosure, by making a thickness of pocket formation parts of a cage for a ball bearing smaller than that of partitions, it is possible to reduce interference with the ball even if cage deformation occurs due to a centrifugal force during high-speed rotation of the ball bearing.

### BRIEF DESCRIPTION OF DRAWINGS

FIG. 1 exemplarily shows a cage according to an example embodiment of the present disclosure.

FIG. 2 exemplarily shows a plan view of the cage according to an example embodiment of the present disclosure.

FIG. 3 exemplarily shows a pocket formation part of the cage according to an example embodiment of the present disclosure when viewed from the outside.

FIG. 4 exemplarily shows the pocket formation part of the cage according to an example embodiment of the present disclosure when viewed from the inside.

FIG. 5 exemplarily shows a cross-sectional view taken along line A-A of FIG. 2.

FIG. 6 exemplarily shows balls supported in the cage according to an example embodiment of the present disclosure.

FIGS. 7 to 9 exemplarily show supply of oil to balls in a cage according to an example embodiment of the present disclosure.

### DETAILED DESCRIPTION OF THE INVENTION

A cage for a ball bearing comprising: a cage main body having a ring shape; a plurality of partitions which extend in an axial direction of the cage main body and are formed spaced apart in a circumferential direction of the cage main body; and pocket formation parts which are formed around the plurality of partitions, wherein pockets are formed between the plurality of partitions adjacent to each other and the pocket formation parts are formed to surround the pockets, and oil storage parts are formed on at least one of an outer surface and an inner surface of the pocket formation parts in a radial direction of the cage main body so that oil stored in the oil storage parts is supplied to the pockets.

### Modes of the Invention

Embodiments which will be described below are provided for the purpose of explaining the technical ideas of the present disclosure and the scope of the rights of the present disclosure is not limited to the embodiments which will be presented below or the specific description thereof.

All technical and scientific terms used herein, unless otherwise defined, have the meaning commonly understood by a person of ordinary skill in the art to which the present disclosure belongs and all terms used herein have been selected for the purpose of more clearly describing the present disclosure and have not been selected to limit the scope of the rights of the present disclosure.

The expressions “comprising,” “including,” “having,” and the like, as used herein, needs to be understood as open-ended terms implying the possibility of including other embodiments, unless otherwise stated in the phrase or sentence in which the expression is included.

In this specification, an “axial direction” means a direction of extension of a central axis about which a cage for a ball bearing rotates, a “radial direction” means a direction perpendicular to the “axial direction” and moving away from or closer to the central axis, and a “circumferential direction” means a direction of rotation centered on the “axial direction”.

The singular forms used in this specification may include a plurality of meanings unless otherwise stated and the same applies to the singular forms used in the claims.

When it is said herein that a constituent element is “positioned” or “formed” on one side of another constituent element, it needs to be understood that the constituent element may be positioned or formed in direct contact with one side of the other constituent element or may be positioned or formed with another new constituent element interposed therebetween.

Preferred embodiment of the present disclosure are described in detail below with reference to the attached drawings to a degree that a person having ordinary skill in the art to which the present disclosure belongs may easily practice the present disclosure. In the attached drawings, the same or corresponding constituent elements are indicated by the same reference numerals, and in the description of the embodiments which will be described below, duplicate description of the same or corresponding constituent elements may be omitted. Here, even if a description of a particular constituent element is omitted in the description below, it is not intended that such constituent element is not included in the embodiment.

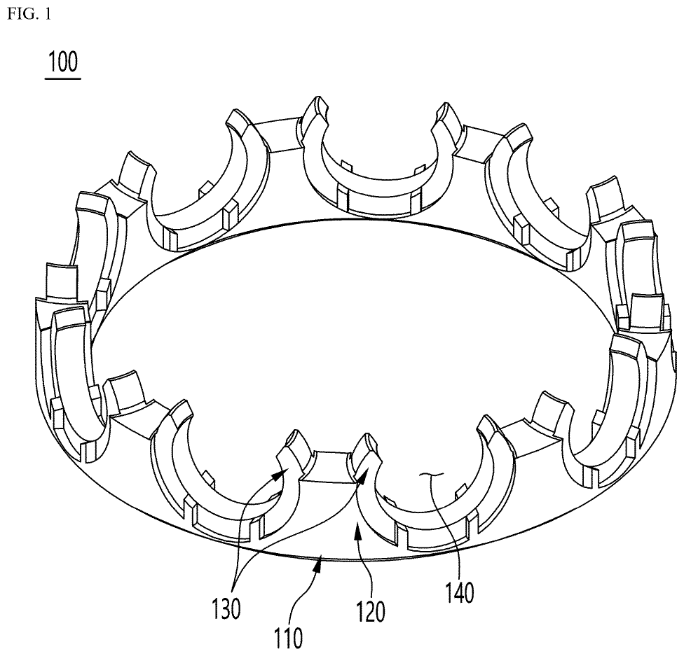

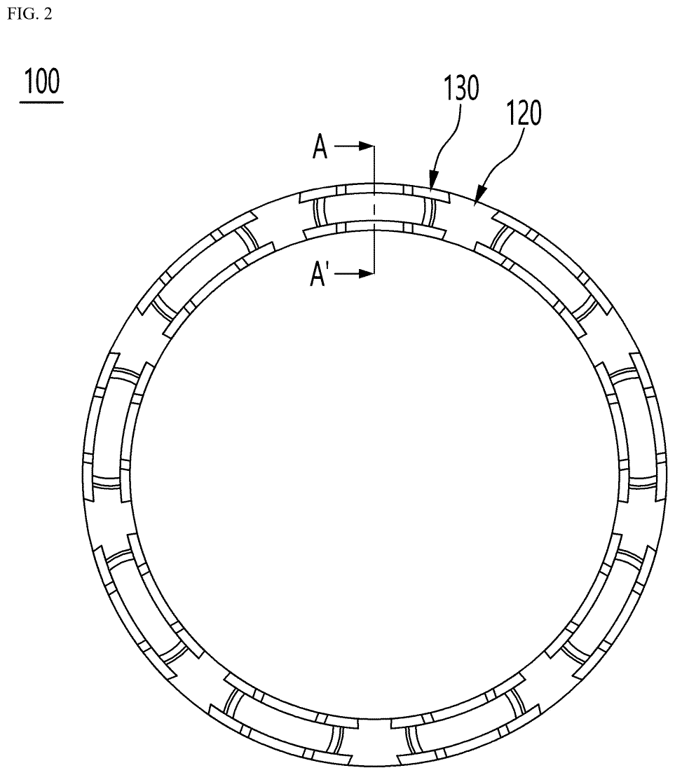

FIG. 1 exemplarily shows a cage according to an example embodiment of the present disclosure and FIG. 2 exemplarily shows a plan view of the cage according to an example embodiment of the present disclosure.

A cage 100 according to an example embodiment of the present disclosure may be a cage used for a ball bearing. Referring to FIGS. 1 and 2, the cage 100 may comprise a cage main body 110, partitions 120, and pocket formation parts 130.

According to an example embodiment of the present disclosure, the cage main body 110 may be formed to have a ring shape and may form a basic structure of the cage 100.

According to an example embodiment of the present disclosure, the partitions 120 may be formed to extend in an axial direction of the cage main body 110, and a plurality of partitions 120 may be formed spaced apart in a circumferential direction of the cage main body 110.

According to an example embodiment of the present disclosure, pockets 140 may be formed between the plurality of partitions 120 adjacent to each other in the circumferential direction. The pockets 140 may be configured such that balls that are rolling elements are seated therein and may be formed as a curved surface of approximately a spherical shape.

According to an example embodiment of the present disclosure, the pocket formation parts 130 may be formed around the partitions 120 to form the pocket 140. Specifically, the pocket formation parts 130 may be formed on both sides of the partition 120 in the circumferential direction and may be formed to surround the pocket 140. The pocket formation part 130 may be formed to have a roughly spherical surface so that balls may be used as rolling elements.

According to an example embodiment of the present disclosure, an oil storage part(s) may be formed on at least one of an outer surface and an inner surface in a radial direction of the pocket formation part 130. The oil storage part may be configured to store oil and supply oil to the pocket 140 to smoothly supply oil to the ball and reduce friction. In addition, the detailed configuration of the oil storage part will be described later.

According to an example embodiment of the present disclosure, the pocket formation part 130 may have a ball support part formed to further protrude in the axial direction than the partition 120 adjacent thereto. The ball support part may have a structure in which a position of the rotating ball is maintained while being seated in the pocket 140, while minimizing interference with the ball.

On the other hand, although not shown in the drawing, according to an example embodiment of the present disclosure, the cage main body 110 may have a weight loss part formed therein. The weight loss part may be formed on a bottom surface of the cage main body 110, that is, an opposite lateral surface to which the partition 120 is formed and may be formed of a plurality of grooves formed spaced apart from each other approximately in the circumferential direction or may be formed of a single long groove extending in the circumferential direction. Such a weight loss part may contribute to reducing a weight of the cage, thereby preventing deformation of the cage due to a centrifugal force during high-speed rotation.

As described above, the present disclosure is characterized by having an oil storage part(s) in the cage to smoothly supply lubricant (oil) to the balls that are rolling elements and reduce friction. Configurations of the oil storage part of the cage will be described in detail below with reference to the drawings.

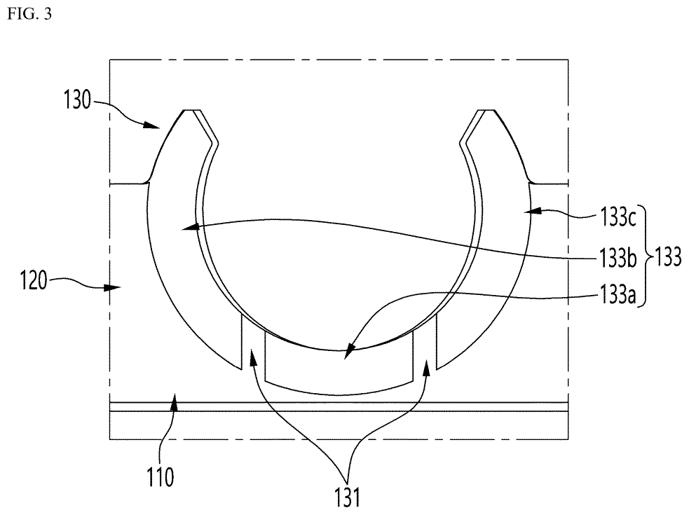

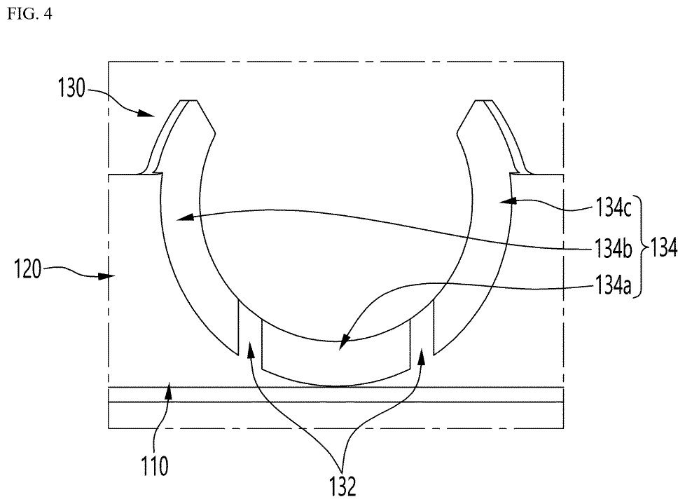

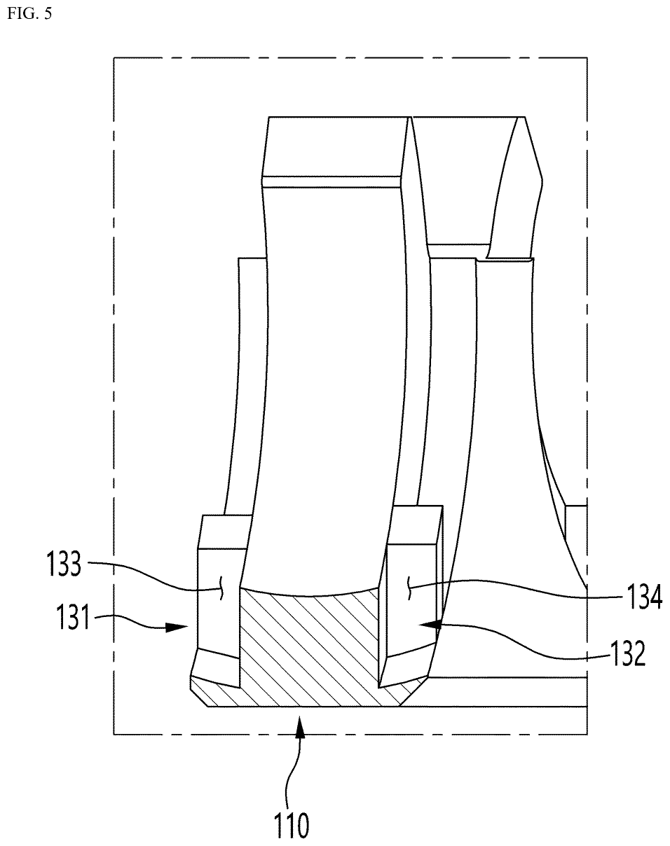

FIG. 3 exemplarily shows a pocket formation part of the cage according to an example embodiment of the present disclosure when viewed from the outside, FIG. 4 exemplarily shows the pocket formation part of the cage according to an example embodiment of the present disclosure when viewed from the inside, and FIG. 5 exemplarily shows a cross-sectional view taken along line A-A of FIG. 2.

Referring to FIGS. 3 to 5, a first oil storage part 133 and a second oil storage part 134 may be formed on the outer surface and the inner surface of the pocket formation part 130 according to an example embodiment of the present disclosure, respectively. The oil storage parts 133 and 134 may be groove portions formed in the pocket formation part 130 and may provide a space for capturing and storing oil. On the other hand, in the example embodiment, it is described that the oil storage part is formed on each of the outer surface and the inner surface of the pocket formation part 130, however it is also included in the scope of the present disclosure that the oil storage part is formed on only one of the outer surface and the inner surface of the pocket formation part 130.

Referring to FIG. 3, the first oil storage part 133 may be formed on the outer surface of the pocket formation part 130 and may be divided into a plurality of regions by a first protrusion part 131 protruding from the pocket formation part 130.

According to an example embodiment of the present disclosure, on the outer surface of the pocket formation part 130, two first protrusion parts 131 are formed to protrude, thereby allowing the first oil storage part 133 to be divided into a first storage part 133a adjacent to the cage main body 110, a second storage part 133b and a third storage part 133c disposed on both sides of the first storage part 133a and adjacent to the partition 120. The first protrusion part 131 may be formed in a direction in which it extends from the cage main body 110 in the axial direction in a region adjacent to the cage main body 110. Further, the first protrusion parts 131 may be disposed spaced apart from each other in the circumferential direction, and may be formed symmetrically with respect to the pocket formation part 130. Here, the location, the extension direction, the number of sections of the first protrusion part 131, the number of compartments of the first oil storage part 133, and the like are not limited to those illustrated and it needs to be understood that the present disclosure is not limited to the illustrated examples.

According to an example embodiment of the present disclosure, a thickness of the pocket formation part 130 may be formed smaller than that of the cage main body 110 and the partition 120 adjacent thereto. According to the example embodiment, the first protrusion part 131 formed by protruding from the outer surface of the pocket formation part 130 may be formed flat without protruding or being concave with respect to the cage main body 110 or the partition 120 adjacent thereto. Further, a thickness of the portion in which the first protrusion part 131 is formed may be formed to be the same as a thickness of the cage main body 110 or the partition 120 adjacent thereto.

Although not shown in the drawing, according to an example embodiment of the present disclosure, an inclined surface may be formed in the first oil storage part 133 of the pocket formation part 130. For example, the inclined surface may be formed to be inclined in a direction in which it approaches the pocket 140 from the first oil storage part 133. In this way, when the inclined surface is formed, it is possible to effectively store oil in the first oil storage part 133 by the inclined surface.

Referring to FIG. 4, the second oil storage part 134 may also have a similar structure to the first oil storage part 133. Specifically, the second oil storage part 134 may be formed on the inner surface of the pocket formation part 130 and may be divided into a plurality of regions by a second protrusion part 131 protruding from the pocket formation part 130.

According to an example embodiment of the present disclosure, two second protrusion parts 132 may be also formed on the inner surface of the pocket formation part 130. Accordingly, the second oil storage part 134 may be divided into a first storage part 134a adjacent to the cage main body 110 and a second storage part 134b and a third storage part 134c disposed on both sides of the first storage part 134a and adjacent to the partition 120. The second protrusion parts 132 may be formed in a direction in which it extends from the cage main body 110 in the axial direction in a region adjacent to the cage main body 110. Further, the second protrusion parts 132 may be disposed to be spaced apart from each other in the circumferential direction and may be formed symmetrically with respect to the pocket formation part 130. Similarly, the location, the extension direction, the number of the second protrusion part 131, and the number of compartments of the second oil storage part 134 are not limited to those illustrated.

According to an example embodiment of the present disclosure, the second protrusion parts 132 which are formed by protruding from the inner surface of the pocket formation part 130 may be formed flat without protruding or being concave with respect to the cage main body 110 or the partition 120 adjacent thereto. Further, a thickness of a portion in which the second protrusion parts 132 are formed may be formed to be the same as a thickness of the cage main body 110 or the partition 120 adjacent thereto. According to an example embodiment of the present disclosure, an inclined surface may also be formed in the second oil storage part 134 of the pocket formation part 130 to effectively store oil.

In this way, according to an example embodiment of the present disclosure, oil may be captured and stored by the oil storage parts 133 and 134 and oil may be supplied to balls seated in the pockets 140 when the ball bearing is driven. Particularly, when the oil storage parts 133 and 134 are partitioned into the first storage parts 133a and 134a which are adjacent to the cage main body 110 and located at a lower portion based on the drawing and the second storage parts 133b and 134b and the third storage parts 133c and 134c which are adjacent to the partition 120 and are located on both sides based on the drawing, it is possible to effectively capture and store oil and supply oil into the pocket 140. Furthermore, by partitioning the oil storage parts 133 and 134 into a plurality of storage parts, it is possible to more capture and store oil.

Also, according to an example embodiment of the present disclosure, since the pocket formation parts 130 may form the oil storage parts 133 and 134 with a relatively small thickness, it is possible to reduce the oil stirring resistance during high-speed rotation, and even when the cage 100 is deformed using a centrifugal force during high-speed rotation, and it is possible to minimize interference with the ball seated in the pocket 140.

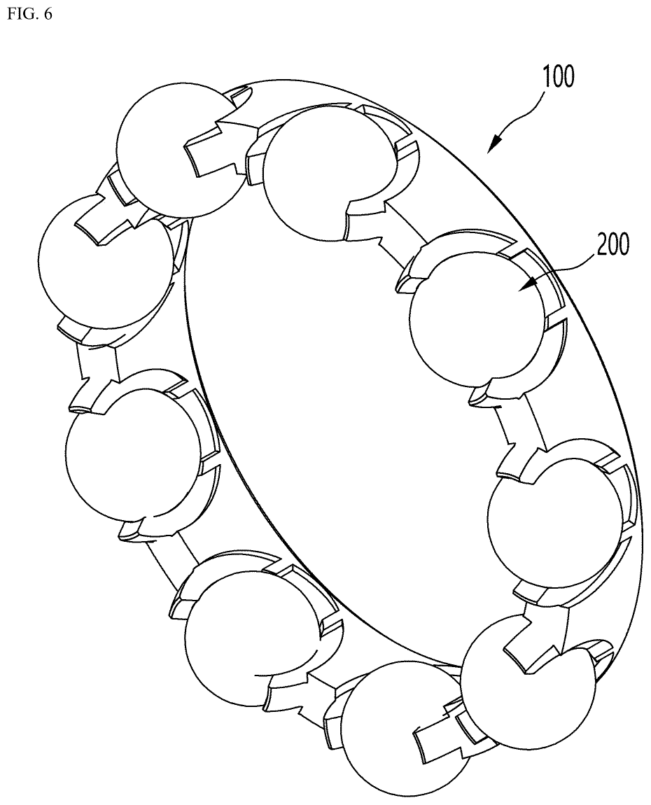

FIG. 6 exemplarily shows balls supported in the cage according to an example embodiment of the present disclosure. As shown in the drawing, the ball 200 may be seated in the pocket 140 of the cage 100 and the position of the ball 200 may be maintained by the cage 100 when the ball bearing rotates. According to an example embodiment of the present disclosure, the oil storage parts 133 and 134 formed in the pocket formation part 130 may be configured to store oil and supply oil to the rotating ball when the ball bearing is driven.

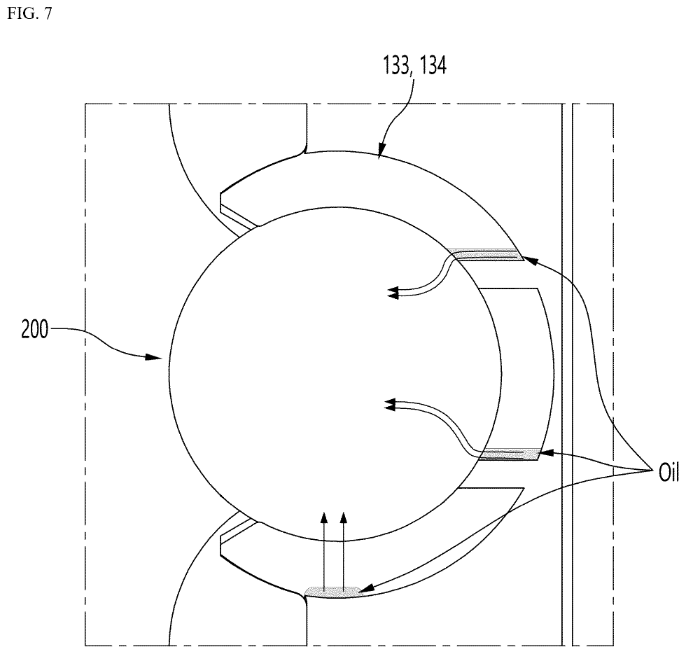

FIGS. 7 to 9 exemplarily show supply of oil to balls in the cage according to an example embodiment of the present disclosure. Specifically, FIGS. 7 to 9 exemplarily show how oil is captured and stored in accordance with the location of the pocket and how oil is supplied therefrom.

FIG. 7 shows a state when the pocket 140 is located on the lateral surface during ball bearing rotation. Referring to FIG. 7, when located on the lateral surface of the pocket 140, oil may be captured and stored in each partitioned storage part of the oil storage parts 133 and 134, and may be captured and stored downward on the basis of the direction of gravity due to its own weight.

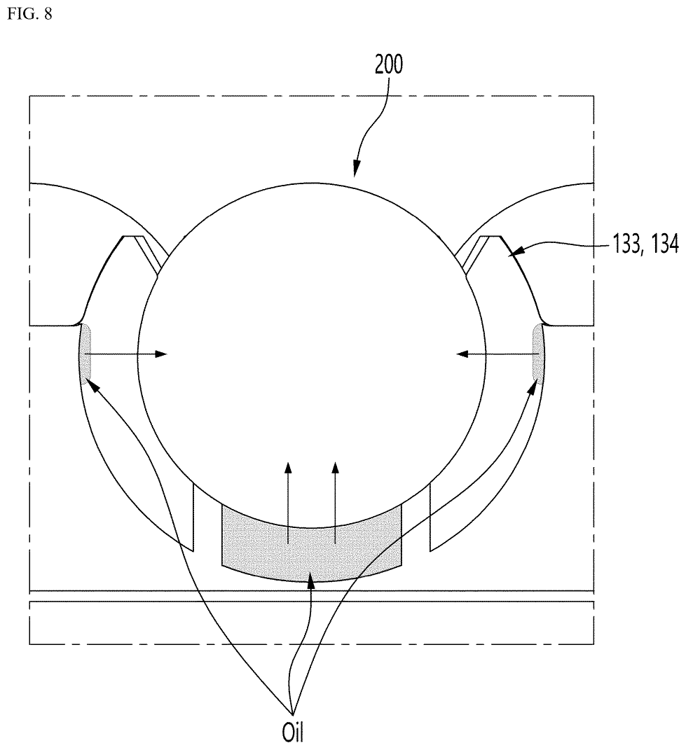

FIG. 8 shows a state when the pocket 140 is located on the upper side when the ball bearing rotates. Referring to FIG. 8, when located on the upper side of the pocket 140, oil may be captured and stored in each partitioned storage part of the oil storage parts 133 and 134, and a large amount of oil may be captured and stored in the storage part adjacent to the cage main body 110 due to its own weight. Some oil may also be captured and stored in the storage part adjacent to partition 120. In addition, in this case, oil may be captured and stored in a region close to partition 120.

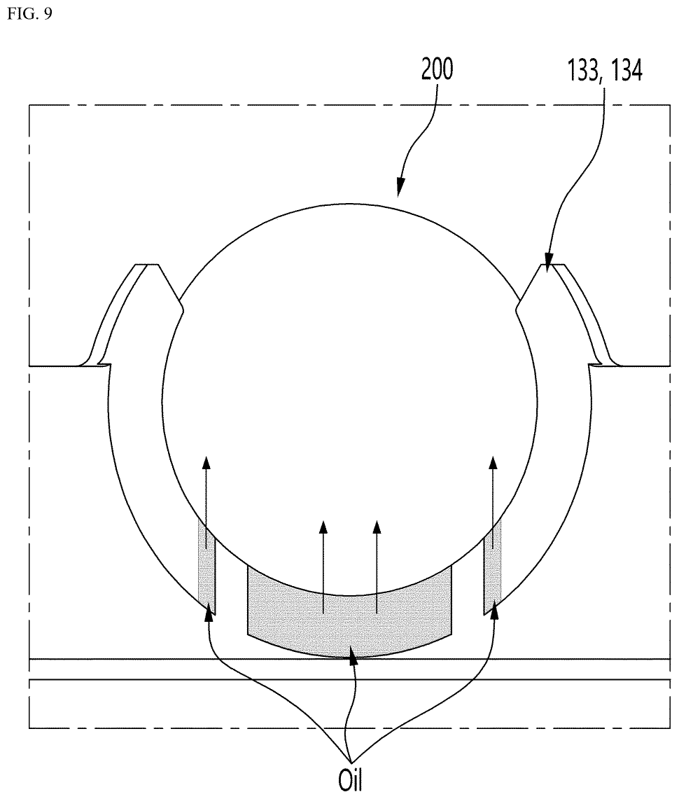

FIG. 9 shows a state when the pocket 140 is located on the lower side when the ball bearing rotates. Referring to FIG. 9, even when located on the lower side of the pocket 140, oil may be captured and stored in each partitioned storage part of the oil storage parts 133 and 134, and a large amount of oil may be captured and stored in the storage part adjacent to the cage main body 110 due to its own weight. Oil may also be captured and stored in the storage part adjacent to the partition 120. In addition, in that case, oil may be captured and stored in a region close to the cage main body 110.

As described above, according to an example embodiment of the present disclosure, the oil storage parts 133 and 134 are configured to capture and store oil and supply oil to rotating balls when the ball bearing is driven. Particularly, the oil storage parts 133 and 134 may perform an initial oil supply function before oil is supplied from the outside when the ball bearing starts to rotate after being in a non-rotating state, for example, when starting an electric vehicle (that is, when the electric motor is driven).

Generally, it may take some time for an electric motor to start operating and for oil to be supplied from the outside, and during that time, friction may occur significantly due to the lack of oil supply and damage to the raceway surfaces and balls may occur due to frictional heat. However, according to an example embodiment of the present disclosure, the oil storage parts 133 and 134 of the cage 100 may store oil even when the ball bearing is not rotating and supply oil immediately when it starts rotating, thereby reducing friction and preventing damage due to friction.

In addition, according to an example embodiment of the present disclosure, by forming the oil storage parts 133 and 134 in the pocket formation part 130 and partitioning the oil storage parts 133 and 134 into several regions using the protrusion parts 131 and 132, it is possible to more capture and store oil. This can contribute to improving lubricity and reducing frictional heat.

Furthermore, according to an example embodiment of the present disclosure, by reducing the thickness of the pocket formation part 130 and reducing the contact area with the ball, it is possible to minimize interference between the cage and the ball even when the ball bearing rotates at high speed.

On the other hand, according to an example embodiment of the present disclosure, the ball bearing including the cage described above may be provided. Specifically, the ball bearing according to an example embodiment of the present disclosure may comprise an inner ring, an outer ring disposed opposite the inner ring, a plurality of balls disposed between the inner ring and the outer ring and spaced apart from each other by a predetermined interval, and a cage disposed between the inner ring and the outer ring and configured to maintain the plurality of balls by a predetermined interval. Configurations of the inner ring, the outer ring, and the ball of the ball bearing may be the same as the generally known configurations and the configuration of the cage may be as described above. Such a ball bearing according to an example embodiment of the present disclosure may be particularly suitable for use at high speeds.

Although the present disclosure has been described with specific details such as specific components and limited examples, the examples are provided only to help a more general understanding of the present disclosure and the present disclosure is not limited thereto and a person having ordinary knowledge in the technical field to which the present disclosure belongs may make various modifications and variations from this description.

Therefore, the idea of the present disclosure need not to be limited to the embodiments described above and not only the claims which will be described below but also all modifications equivalent to or equivalent to the claims are considered to fall within the scope of the idea of the present disclosure.

### EXPLANATION OF REFERENCE NUMERALS

100 Cage
110 Cage main body
120 Partition
130 Pocket formation part
131 First protrusion part
132 Second protrusion part
133 First oil storage part
134 Second oil storage part
140 Pocket
200 Ball

### INDUSTRIAL APPLICABILITY

According to the present disclosure, it is possible to improve lubrication by smoothly supplying lubricating oil even when a ball bearing rotates at high speed. Particularly, according to the present disclosure, it is possible to supply oil stored in oil storage parts to the balls even at the initial stage of starting, thereby reducing friction and suppressing the generation of frictional heat.

Also, according to the present disclosure, by making the thickness of the pocket formation parts of the cage for a ball bearing smaller than that of the partition, it is possible to reduce interference with the ball even if cage deformation occurs due to a centrifugal force during high-speed rotation of the ball bearing.

What is claimed is:

1. A cage (100) for a ball bearing, comprising:
a cage main body (110) having a ring shape;
a plurality of partitions (120) which extend in an axial direction of the cage main body (110) and are formed spaced apart in a circumferential direction of the cage main body (110); and
pocket formation parts (130) which are formed around the plurality of partitions (120),
wherein pockets (140) are formed between the plurality of partitions (120) adjacent to each other and the pocket formation parts (130) are formed to surround the pockets (140), and
oil storage parts (133) and (134) are formed on at least one of an outer surface and an inner surface of the pocket formation parts (130) in a radial direction of the cage main body (110) so that oil stored in the oil storage parts (133) and (134) is supplied to the pockets (140).

2. The cage for a ball bearing of claim 1, wherein the pocket formation part (133) has at least one of protrusion parts (131) and (132) formed to protrude and the oil storage parts (133) and (134) are partitioned into two or more compartments by the at least one of the protrusion parts (131) and (132).

3. The cage for a ball bearing of claim 2, wherein, in the pocket formation part (133), two of the protrusion parts (131) and (132) are formed to protrude, and the oil storage parts (133) and (134) are partitioned into a first storage part adjacent to the cage main body (110), and a second storage part and a third storage part adjacent to the partition (120) on both sides of the first storage part by the two protrusion parts (131) and (132).

4. The cage for a ball bearing of claim 2, wherein a thickness of the at least one of the protrusion parts (131) and (132) in a radial direction of the cage main body (110) is formed to be the same as a thickness of the plurality of partitions (120).

5. The cage for a ball bearing of claim 1, wherein a thickness of the oil storage parts (133) and (134) formed in the pocket formation part (130) in a radial direction of the cage main body (110) is formed smaller than a thickness of the plurality of partitions (120).

6. The cage for a ball bearing of claim 1, wherein the pocket formation part (130) comprises a ball support part formed to protrude further than the plurality of partitions (120) in a direction in which it is away from the cage main body (110).

7. The cage for a ball bearing of claim 1, wherein first oil storage parts (133) are formed on an outer surface in a radial direction of the pocket formation part (130) and second oil storage parts (134) are formed on an inner surface in the radial direction of the pocket formation part (130).

8. A ball bearing, comprising:
an inner ring;
an outer ring which is disposed opposite the inner ring;
a plurality of balls which is disposed between the inner ring and the outer ring and spaced apart from each other at a predetermined interval; and
a cage which is disposed between the inner ring and the outer ring and configured to maintain the plurality of balls at a predetermined interval,
wherein the cage (100) comprises:
a cage main body (110) formed to have a ring shape;
a plurality of partitions (120) which extend in an axial direction of the cage main body (110) and are formed spaced apart in a circumferential direction of the cage main body (110); and
pocket formation parts (130) which are formed around the plurality of partitions (120),
pockets (140) are formed between the plurality of partitions (120) adjacent to each other and the pocket formation parts (130) are formed to surround the pockets (140), and
oil storage parts (133) and (134) are formed on at least one of the outer surface and the 10 inner surface of the pocket formation parts (130) in a radial direction of the cage main body (110) so that the oil stored in the oil storage parts (133) and (134) is supplied to the pockets (140).
